(19) United States
(12) Patent Application Publication
(10) Pub. No.: US 2025/0316781 A1
(43) Pub. Date: Oct. 9, 2025

(54) ACTIVATED CARBON CARTRIDGE, EXPANSION TANK AND BATTERY COOLING SYSTEM

(71) Applicant: MAHLE International GmbH, Stuttgart (DE)

(72) Inventors: Markus Lang, Loechgau (DE); Ralf Zink, Stuttgart (DE)

(21) Appl. No.: 18/981,412

(22) Filed: Dec. 13, 2024

(30) Foreign Application Priority Data
Dec. 15, 2023 (DE) 10 2023 135 281.4

(51) Int. Cl. H01M 10/52; H01M 10/613; H01M 50/317

(52) U.S. Cl. CPC H01M 10/52; H01M 10/613; H01M 50/317

(57) ABSTRACT

An activated carbon cartridge for an expansion tank for a battery cooling system is disclosed. The activated carbon cartridge includes a cartridge housing with a body and a cover. A base of the body and the cover (18) are structured to be air-permeable. Activated carbon is disposed in the cartridge housing. A seal is arranged on the base of the body for sealing against an intermediate wall of a container housing of the expansion container. A spring is supported on the lid.

### CROSS-REFERENCE TO RELATED APPLICATIONS

This application claims priority to Germany Patent Application No. DE 10 2023 135 281.4 filed on Dec. 15, 2023, the contents of which are hereby incorporated by reference in their entirety.

### TECHNICAL FIELD

The present invention relates to an activated carbon cartridge for an expansion tank for a battery cooling system. The invention also relates to an expansion tank with such an activated carbon cartridge and a battery cooling system with such an expansion tank.

### BACKGROUND

Electric or hybrid vehicles are increasingly becoming the focus of consumers due to their environmental aspects and are therefore becoming increasingly common on the roads. In order to be able to increase both the range and the performance of such electric or hybrid vehicles, the aim is to keep a traction battery of such an electric or hybrid vehicle in a temperature window that is optimal for this traction battery, for which purpose temperature control devices, in particular cooling devices, are used in a known manner.

Such a battery cooling system for cooling, in particular, a traction battery, also includes an expansion tank in which air is kept as a compensating cushion for a temperature-related change in the volume of the coolant. An increase in temperature causes the coolant to expand, which, if the resulting excess pressure cannot escape, can lead to a high pressure load in the expansion tank, and could possibly damage it, and should therefore be avoided. For this reason, such expansion tanks usually have a connection to the environment in order to be able to reduce a temperature-related pressure difference by blowing air out into the environment if necessary. In order to prevent or at least reduce the undesirable discharge of hydrocarbon compounds into the environment, activated carbon filters were previously provided through which the air to be blown out into the environment flowed, and which were arranged separately from the expansion tank. When the coolant cools down, it contracts, creating a negative pressure in the expansion tank, which causes fresh air to be drawn in from the surrounding area. In order to prevent or at least reduce unwanted moisture ingress into the coolant, so-called dryer cartridges were previously provided in which a drying agent was arranged, through which the fresh air sucked in from the environment flowed during the suction process, absorbing moisture and drying the sucked-in fresh air.

The disadvantage of known activated carbon filters, however, is their comparatively large additional space requirement and the complex installation.

The present invention therefore addresses the problem of providing an improved, or at least an alternative, embodiment for an activated carbon filter for an expansion tank for a battery cooling system, by means of which the disadvantages known from the prior art can be overcome.

According to the invention, this problem is solved by the subject of independent claim(s). Advantageous embodiments are the subject of the dependent claims.

### SUMMARY

The present invention is based on the general idea of providing for the first time an activated carbon cartridge which can be inserted extremely easily in a form-fitting manner in an expansion tank of a battery cooling system. In order to be able to produce such a positive connection, the activated carbon cartridge according to the invention for an expansion tank for a battery cooling system has a cartridge housing with a body and a cover, wherein the base of the body and the cover are designed to be air-permeable at least in regions, and are in particular covered on the inside with a fabric or a fleece. The activated carbon is arranged in the cartridge housing. The fleece prevents the unwanted discharge of activated carbon. In addition, a seal arranged on the bottom of the body is provided for sealing against an intermediate wall of a container housing of the expansion tank, whereby this seal encloses the air-permeable area on the base of the body. A spring is also provided, which is supported on the lid. This not only allows the activated carbon cartridge to be arranged in the container housing of the expansion tank in a space-optimized manner, but also gives it fixed external dimensions, which allow it to be positively accommodated in a complementary receptacle in the container housing. The cartridge housing also makes it relatively easy to replace the activated carbon cartridge by removing it from the container housing and inserting a new activated carbon cartridge into the corresponding holder. The seal and the spring can also be used to clamp the activated carbon cartridge in the corresponding holder in the container housing, thus ensuring reliable fixation and sealing.

In an advantageous development of the activated carbon cartridge according to the invention, the cover can be moved like a piston in the body. In addition, the activated carbon is arranged as a fill/bulk material in the cartridge housing. In this case, the spring, which is supported on the lid on the one hand and on the container housing on the other, can pre-tension the free-flowing activated carbon, which means that it is not ground up or worn out during operation. Such a filling also allows maximum possible utilization of the interior space of the cartridge housing formed by the body and the cover and thus the arrangement of as much activated carbon as possible, whereby a high degree of filtration or retention can be achieved. The spring can also be used to permanently re-tension the activated carbon, which reduces wear and tear on the activated carbon and thus maintains its filter performance in the long term.

In an alternative embodiment to the activated carbon cartridge according to the invention, the activated carbon is pressed into a honeycomb-shaped activated carbon monolith and can therefore be used without a cartridge housing. Such an activated carbon monolith offers the great advantage that the separation function can be designed not only in a resource-saving manner, but also in a weight-optimized manner. The time-consuming and dust-generating filling and weighing of the loose activated carbon as well as the cartridge housing are no longer necessary.

In an alternative embodiment to the activated carbon cartridge, the activated carbon is arranged on/in a wound filter or a folded filter, i.e., without the cartridge housing. The activated carbon is therefore applied to the wound or folded filter. Such an embodiment offers the great advantage that not only hydrocarbons can be retained via the activated carbon and the wound filter or the folding filter, but also, depending on the design of the carrier material of the wound filter or the folding filter, other particles, such as dirt particles.

The cartridge housing is expediently formed from plastic. Making both the body and the cover out of plastic offers the advantage that the cartridge housing is not only lightweight but also extremely flexible, particularly by adapting the plastic injection molding tool to different dimensions. In addition, the design of the cartridge housing from plastic, especially as a plastic injection-molded part, also enables cost-effective production.

The present invention is further based on the general idea of designing an expansion tank of a battery cooling system for compensating an air volume due to a temperature-related volume change of a cooling medium, in particular oil, with a two-shell container housing with a second receptacle in which the activated carbon cartridge or a honeycomb-shaped activated carbon monolith or a wound filter with activated carbon embedded therein or a folding filter with activated carbon embedded therein can be arranged in a form-fitting manner. The expansion tank according to the invention, in particular for air, for a battery cooling system has the previously mentioned container housing made of plastic with a first shell and a second shell tightly connected thereto. In the first shell and/or in the second shell, a first receptacle is formed in which a dryer cartridge with a drying agent, for example zeolite or silica gel, is received in a form-fitting manner, while in the second receptacle, which can also be arranged in the first shell and/or in the second shell, an activated carbon cartridge according to the invention or a honeycomb-shaped activated carbon monolith or a wound filter with activated carbon embedded therein or a folded filter with activated carbon embedded therein is arranged in a form-fitting manner.

Such an activated carbon cartridge, like a honeycomb-shaped activated carbon monolith, a wound filter with embedded activated carbon, or a pleated filter with embedded activated carbon, is able to absorb pollutants such as hydrocarbons. Furthermore, a first valve is provided, via which air can be blown out of the expansion tank into the environment when there is an overpressure in the expansion tank, and a second valve, via which fresh air can be sucked into the expansion tank from the environment when there is a negative pressure in the expansion tank. The term “fresh air” can/should be understood to mean ambient air. The two-shell design of the container housing of the expansion tank with the dryer cartridge and, for example, the activated carbon cartridge arranged therein makes it possible to create an overall very cost-effective container housing for the expansion tank, which also results in assembly advantages, since the dryer cartridge designed as an insert only needs to be inserted in a form-fitting manner into the first receptacle of the first and/or second shell and the activated carbon cartridge designed as an insert only needs to be inserted into the second receptacle of the first and/or second shell and the two shells of the container housing then need to be tightly connected to one another. This also makes it possible to arrange the dryer cartridge or activated carbon cartridge in the container housing in a way that is protected over its lifetime. The same applies, of course, to a honeycomb-shaped activated carbon monolith used instead of the activated carbon cartridge or a wound filter with embedded activated carbon or a pleated filter with embedded activated carbon. This means that the previously required manufacture of the container housing and subsequent installation of the dryer cartridge or the activated carbon cartridge or the honeycomb-shaped activated carbon monolith or the wound filter or the folded filter can be completely eliminated. The production of the expansion tank according to the invention can in particular even be carried out automatically, since the inner contour of the first receptacle, which is essentially complementary to an outer contour of the dryer cartridge, and the inner contour of the first receptacle, which is essentially complementary to an outer contour of the activated carbon cartridge, of the honeycomb-shaped activated carbon monolith, the wound filter, or the folding filter, a form-fitting insertion of the dryer cartridge into the first receptacle and the activated carbon cartridge, of the honeycomb-shaped activated carbon monolith, the wound filter, or the folded filter can be placed into the second holder without the need for a worker. Due to the arrangement of both the first valve and the second valve on the container housing, these two valves can also be replaced if the dryer cartridge/activated carbon cartridge, the honeycomb-shaped activated carbon monolith, the wound filter or the folding filter, and/or if the container housing needs to be replaced, which can reliably prevent the valves from becoming clogged, for example due to excessive use.

In an advantageous development of the expansion tank according to the invention, the first valve is arranged in an intermediate wall which separates the second receptacle from an interior of the tank housing. Air is usually arranged in the interior of the container housing, which is subjected to pressure or negative pressure by expansion or contraction of the coolant, depending on the temperature of the coolant. By arranging the first valve in the intermediate wall which separates the second receptacle from the interior of the container housing, a direct assignment of the first valve to the second receptacle can be achieved. Downstream of the second receptacle, an opening is of course provided in a wall of the container housing to the outside for exchange with the environment.

The second valve is arranged in an outer wall of the container housing, wherein the outer wall in which the second valve is arranged separates the first receptacle from the environment. Fresh air is sucked in from the environment when there is a negative pressure in the container housing or in the expansion tank via the second valve and the first receptacle in which the dryer cartridge is arranged. The fresh air drawn in from the environment is therefore sucked in by the drying agent of the dryer cartridge and dried in the process, which in particular prevents moisture and/or water from entering the expansion tank or the battery cooling system. Excessive humidity could make the coolant electrically conductive, which under unfavorable circumstances, especially in immersion cooling, could lead to a short circuit.

The second valve described can also be designed as a double valve, which also allows air to be blown out of the container housing into the environment.

In addition, the respective inlet and outlet of the expansion tank, which interact with the atmosphere, can be provided with additional protective caps. These protect the valve or the internal activated carbon cartridge from improper ingress of water, dust, or other unwanted foreign bodies.

In a particularly preferred embodiment, a spring is arranged on the dryer device or on the activated carbon cartridge, which preloads the dryer cartridge or the activated carbon cartridge against the container housing. Such springs can be used to achieve a reliable and positionally fixed arrangement of the dryer cartridge in the first receptacle and the activated carbon cartridge in the second receptacle, whereby the spring preload simultaneously prevents the dryer cartridge and/or the activated carbon cartridge from generating rattling noises during operation, for example, which are perceived as annoying. Such a spring can, for example, be designed as a cost-effective helical spring, wherein the helical spring for pre-tensioning the dryer cartridge can be arranged in the first receptacle in such a way that it engages around the second valve in the outer wall of the container housing and is thereby fixed by the second valve. The spring can also be used to pre-tension the activated carbon or drying granulate, for example in the form of bulk material, provided that the cover can be moved in the body like a piston, which means that it experiences less wear during operation.

In a particularly preferred embodiment of the expansion tank according to the invention, the first shell and/or the second shell are designed as plastic injection-molded part(s). The design of the first and/or second shell as plastic injection-molded parts offers the great advantage of being able to manufacture the tank housing, and thus also the expansion tank, not only with high quality but also cost-effectively.

The first shell and the second shell are conveniently welded together. When designing the two shells as plastic injection-molded parts, it is advisable to weld them together to ensure a tight connection between the two shells. Alternatively, it is of course also possible to glue the two shells together. Alternatively, it is theoretically possible that the two shells are connected to each other via clip connections or screw connections, which offers the great advantage that for replacing the dryer cartridge or the activated carbon cartridge, the honeycomb activated carbon monolith, wound filter, or folded filter, the container housing is opened and can be reused after replacing the dryer cartridge or the activated carbon cartridge, honeycomb activated carbon monolith, wound filter, or folded filter. In this case, a seal must be inserted between the two trays.

In a further advantageous embodiment of the expansion tank according to the invention, the first shell and/or the second shell are made of polyoxymethylene (POM). POM is a semi-crystalline thermoplastic with high mechanical strength and rigidity and, in addition, high wear resistance and low moisture absorption, which is of great advantage especially when used for the expansion tank according to the invention, since in this case water retention or moisture absorption increases the electrical conductivity of a dielectric coolant. Alternatively, polyketone can be used as a plastic for the first and/or second shell. Polyketones (PK) are high-performance thermoplastic polymers with high impact strength, low wear, good solvent resistance, and low water absorption. Polyketone is also highly environmentally compatible. In order to further increase the mechanical strength and also the wear resistance, the plastic can contain glass fibers, in particular 25% glass fibers, and can in particular be designed as POM GF-25.

The present invention is further based on the general idea of equipping a battery cooling system with an expansion tank described in the previous paragraphs and thereby transferring the advantages described with regard to the expansion tank to the battery cooling system. Specifically, the advantages of a battery cooling system equipped with the expansion tank according to the invention lie in cost-effective production, whereby for a regular replacement of the dryer cartridge and/or the activated carbon cartridge, the honeycomb-shaped activated carbon monolith, the wound filter, or the folding filter, only the expansion tank or, in the case of an openable container housing of the expansion tank, only the dryer cartridge and/or the activated carbon cartridge, the honeycomb-shaped activated carbon monolith, the wound filter, or the folding filter have to be replaced.

Other important features and advantages of the invention can be seen from the dependent claims, from the drawings, and from the associated description of the figure based on the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawings.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

These show, schematically in each case, in

FIG. 1 a view of an expansion tank according to the invention of a battery cooling system according to the invention,

FIG. 2 a representation as in FIG. 1, but from a different perspective,

FIG. 3 an exploded view of the buffer vessel according to the invention,

FIG. 4 a sectional view of an activated carbon cartridge according to the invention,

FIG. 5 a frontal view of activated carbon formed as an activated carbon monolith of the activated carbon cartridge according to the invention,

FIG. 6 a frontal view of a wound filter with activated carbon of the activated carbon cartridge according to the invention,

FIG. 7 an oblique view of a pleated filter with activated carbon of the activated carbon cartridge according to the invention.

### DETAILED DESCRIPTION

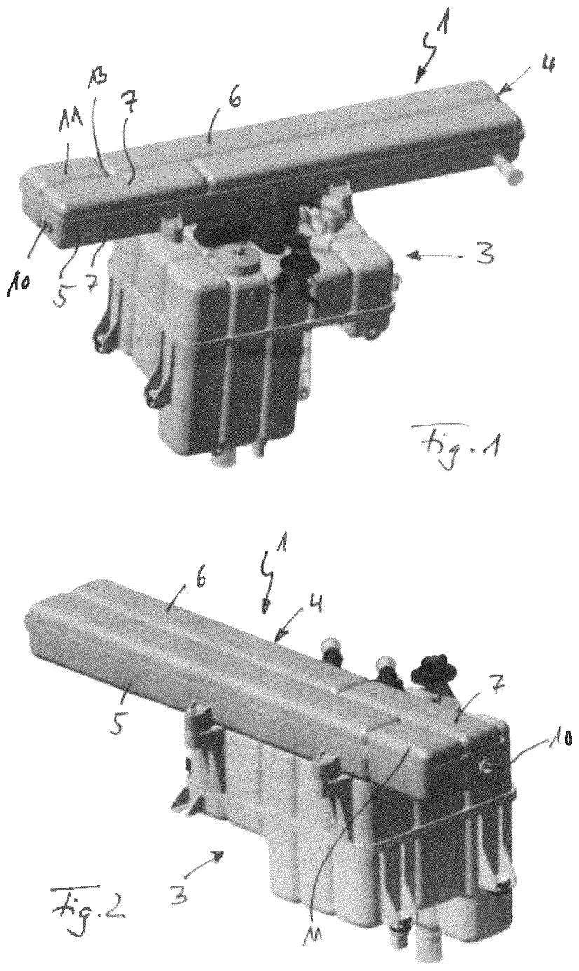

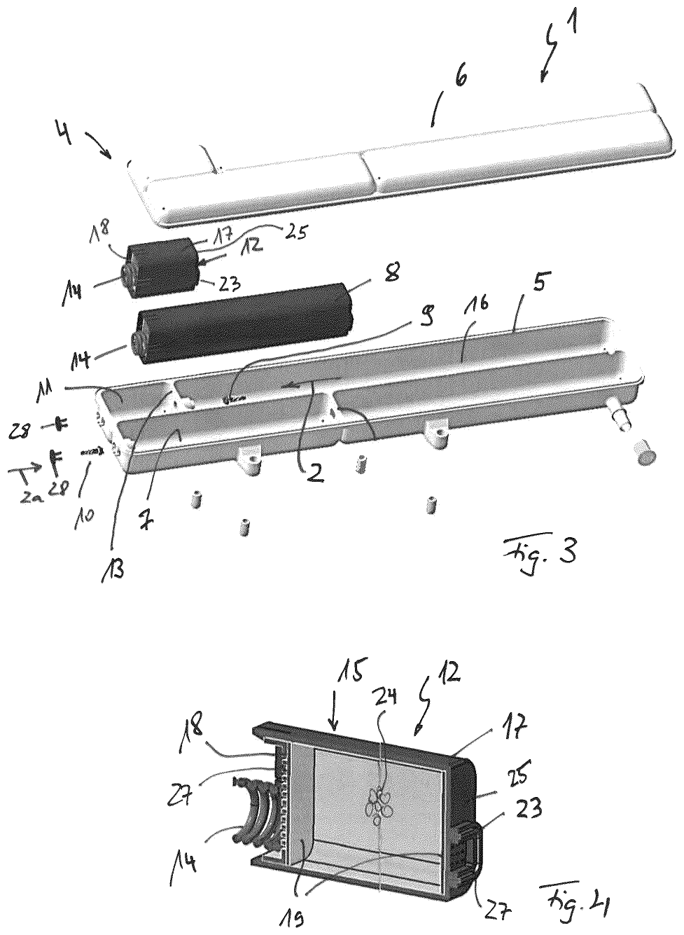

According to FIGS. 1 to 3, an expansion tank 1 according to the invention for air 2 of a battery cooling system 3 according to the invention has a container housing 4 made of plastic with a first shell 5 and a second shell 6 connected thereto. In the first shell 5 and/or in the second shell 6, a first receptacle 7 (see FIG. 3) is provided or formed, in which a dryer cartridge 8 is arranged in a form-fitting manner. An unspecified drying agent, for example zeolite or silica gel, is arranged in the dryer cartridge 8. Furthermore, the expansion tank 1 according to the invention has a first valve 9, via which air 2 can be blown out of the expansion tank 1 into the environment when there is an overpressure in the expansion tank 1. When there is a negative pressure in the expansion tank 1, fresh air 2a from the environment enters the expansion tank 1 via a second valve 10.

In the first shell 5 and/or the second shell 6, a second receptacle 11 is further formed, in which an activated carbon cartridge 12 according to the invention (see also FIG. 4) is received in a form-fitting manner. As an alternative to the activated carbon cartridge 12, the second receptacle 11 can also accommodate a honeycomb-shaped activated carbon monolith 20, a wound filter 21 with embedded activated carbon 24, or a pleated filter 22 with embedded activated carbon 24 can be arranged in a form-fitting manner.

The expansion tank 1 shown thus has the tank housing 4 with the two receptacles 7, 11 arranged therein, in which the dryer cartridge 8 or the activated carbon cartridge 12 or the honeycomb-shaped activated carbon monolith 20 or the wound filter 21 or the folded filter 22 are arranged. In the following description of the figures, reference is primarily made to the activated carbon cartridge 12, whereby all statements should also apply analogously to an activated carbon monolith 20 arranged instead of the activated carbon cartridge 12 or a wound filter 21 with activated carbon 24 embedded therein or a folded filter 22 with activated carbon (24) embedded therein.

When there is an overpressure in the expansion tank 1, air 2 flows out into the environment through the first valve 9 and the activated carbon cartridge 12 arranged in the second receptacle 11. By blowing out air 2 through the activated carbon cartridge 12, the honeycomb-shaped activated carbon monolith 20, or the wound filter 21 or the folded filter 22, pollutants such as hydrocarbons can be reliably retained. Fresh air 2a is sucked from the environment into the buffer container 1 via the second valve 10 and the dryer cartridge 8, in which the sucked fresh air 2a is dried. A protective cap 28 positioned at the inlet for fresh air 2a or at the outlet for air 2 prevents the entry of unwanted interfering bodies, dirt particles, etc.

The first valve 9 is arranged in an intermediate wall 13 which separates the second receptacle 11 from the interior 16 of the container housing 4. The second valve 10, which can also be designed as a double valve, i.e., a valve that is permeable in both directions, is arranged in an outer wall of the container housing 4, which separates the first receptacle 7 from the environment. Of course, the previously described second valve 10 and a further pressure relief valve can also be arranged in the outer wall of the container housing 4, via which air 2 is blown out of the expansion tank 1 into the environment.

Looking further at FIG. 3, it can be seen that a spring 14 is arranged on the dryer cartridge 8 and on the activated carbon cartridge 12, which prestresses the dryer cartridge 8 against the container housing 4 and the activated carbon cartridge 12 also against the container housing 4, here specifically against the intermediate wall 13. The two springs 14 ensure that the dryer cartridge 8 and the activated carbon cartridge 12 are fixed in the respective holder 7, 11 without vibration and thus without rattling. This allows in particular to achieve increased user comfort due to lower noise levels.

The activated carbon cartridge 12 for an expansion tank 1 for a battery cooling system 3 has a cartridge housing 15 with a body 17 and a cover 18 which can be displaced therein like a piston, wherein the base 25 of the body 17 and the cover 18 are designed to be permeable to air and are in particular covered on the inside with a fabric or a fleece 19. For this purpose, the cover 18 and the body base 25 have openings 27 (see FIG. 4). The fleece 19 is permeable to air and at the same time prevents unwanted discharge of activated carbon 24 from the cartridge housing 15.

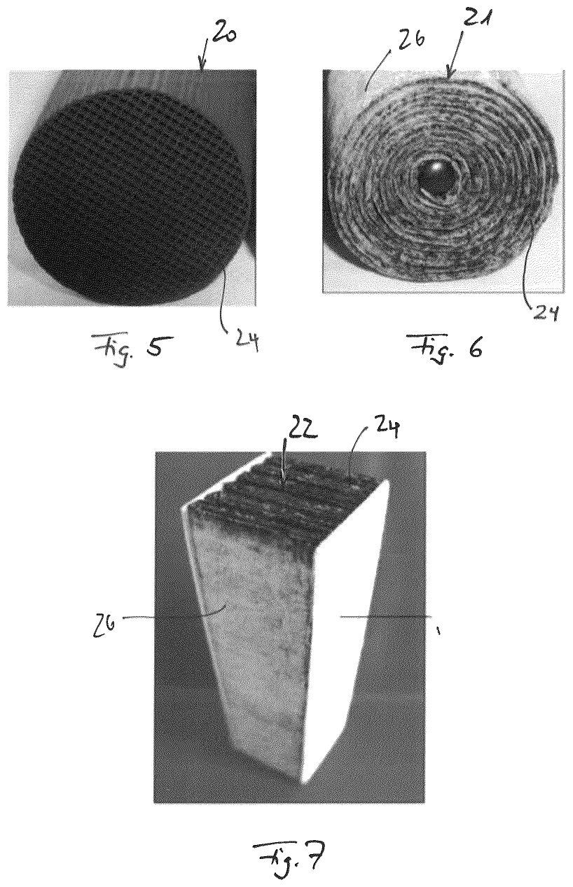

The activated carbon 24 arranged in the cartridge housing 15 can be designed as a bulk material (see FIG. 4). Alternatively, the activated carbon 24 can also be designed as a honeycomb-shaped activated carbon monolith 20 (see FIG. 5) or embedded in a wound filter 21 (see FIG. 6) or a folded filter 22 (see FIG. 7). In the last two cases, the cartridge housing 15 can be omitted. According to FIG. 4, the activated carbon 24 can be pressed to form the activated carbon monolith 20, while the activated carbon 24 according to FIG. 6 can be applied to a carrier material 26, in particular a fleece, of the wound filter 21. In the same way, the activated carbon 24 can also be applied to a carrier material 26, in particular a fleece, in a pleated filter 22 according to FIG. 7.

A seal 23 is arranged on the base 25 of the body 17 for sealing against the intermediate wall 13 of the container housing 4 of the expansion tank 1. The seal 23 encloses the air-permeable area on the base of the body 25. This ensures that the air 2 blown out of the interior 16 due to temperature-related thermal expansion of the coolant necessarily flows through the activated carbon cartridge 12.

The first shell 5 and/or the second shell 6 and/or the cartridge housing 15 can be designed as plastic injection-molded part(s), which enables not only high-quality but also cost-effective production. The two shells 5, 6 can be welded or glued together, although it is theoretically also conceivable that the two shells 5, 6 are connected to each other via clip connections or screw connections, which offers the great advantage that the container housing 4 can be opened to replace the dryer cartridge 8 or the activated carbon cartridge 12 and can continue to be used after the dryer cartridge 8 or the activated carbon cartridge 12 has been replaced.

The first shell 5 and/or the second shell 6 can be made of polyoxymethylene (POM) or polyketone, i.e., of a plastic with high strength and low moisture absorption, which is of great advantage in particular for an expansion tank 1 for air 2 of a battery cooling system 3. In order to further increase the strength and wear resistance of the container housing 4, the plastic of the two shells 5, 6 can be reinforced with fibers, in particular glass fibers.

All in all, the activated carbon cartridge 12 according to the invention, the expansion tank 1 according to the invention, and the battery cooling system 3 according to the invention can create an extremely cost-effective, space-optimized, and maintenance-friendly solution.

1. An activated carbon cartridge for an expansion tank for a battery cooling system, comprising:
a cartridge housing with a body and a cover, wherein a base of the body and the cover are structured to be air-permeable and coated from an inside with a fabric or a fleece,
activated carbon disposed in the cartridge housing,
a seal arranged on the base of the body for sealing against an intermediate wall of a container housing of the expansion tank, and
a spring that is supported on the lid.

2. The activated carbon cartridge according to claim 1, wherein the activated carbon is arranged as a bulk material in the cartridge housing.

3. The activated carbon cartridge according to claim 1, wherein the cover is moveable like a piston in the body.

4. The activated carbon cartridge according to claim 1, wherein the cartridge housing is made of plastic.

5. An expansion tank for a battery cooling system, comprising:
a container housing made of plastic, with a first shell and a second shell connected thereto,
a first receptacle disposed in the first shell and/or in the second shell,
a tumble dryer cartridge that is received in a form-fitting manner in the first receptacle,
a first valve, through which air escapes from the expansion tank into an environment when there is an overpressure in the expansion tank,
a second valve, through which fresh air from the environment enters the expansion tank when there is a negative pressure in the expansion tank,
a second receptacle disposed in the first shell and/or in the second shell,
an activated carbon cartridge or a honeycomb-shaped activated carbon monolith or a wound filter with activated carbon embedded therein or a folded filter with activated carbon embedded therein is received in a form-fitting manner in the second receptacle,
the activated carbon cartridge including:
a cartridge housing with a body and a cover, wherein a base of the body and the cover are structured to be air-permeable and coated from an inside with a fabric or a fleece,
the activated carbon disposed in the cartridge housing,
a seal arranged on the base of the body for sealing against an intermediate wall of a container housing of the expansion tank, and
a spring that is supported on the lid.

6. The expansion tank according to claim 5, wherein the first valve is arranged in an intermediate wall which separates the second receptacle from an interior space of the container housing.

7. The expansion tank according to claim 5, further comprising a second spring that preloads the dryer cartridge against the container housing.

8. The expansion tank according to claim 5, wherein at least one of:
the first shell and/or the second shell is configured as plastic injection-molded part, or
the first shell and the second shell are welded, clipped, screwed, or glued together.

9. The expansion tank according to claim 5, wherein the first shell and/or the second shell is made of polyoxymethylene (POM) or polyketone.

10. The expansion tank according to claim 5, wherein the first shell and/or the second shell comprise glass fibers.

11. The expansion tank according to claim 5, wherein the second valve is arranged in an outer wall of the container housing which separates the first receptacle from the environment.

12. A battery cooling system, comprising: an expansion tank, the expansion tank including:
a container housing made of plastic, with a first shell and a second shell connected thereto,
a first receptacle disposed in the first shell and/or in the second shell,
a tumble dryer cartridge that is received in a form-fitting manner in the first receptacle,
a first valve, through which air escapes from the expansion tank into an environment when there is an overpressure in the expansion tank,
a second valve, through which fresh air from the environment enters the expansion tank when there is a negative pressure in the expansion tank,
a second receptacle disposed in the first shell and/or in the second shell,
an activated carbon cartridge or a honeycomb-shaped activated carbon monolith or a wound filter with activated carbon embedded therein or a folded filter with activated carbon embedded therein is received in a form-fitting manner in the second receptacle,
the activated carbon cartridge including:
a cartridge housing with a body and a cover, wherein a base of the body and the cover are structured to be air-permeable and coated from an inside with a fabric or a fleece,
the activated carbon disposed in the cartridge housing,
a seal arranged on the base of the body for sealing against an intermediate wall of a container housing of the expansion tank, and
a spring that is supported on the lid.

13. The battery cooling system according to claim 12, wherein the first valve is arranged in an intermediate wall which separates the second receptacle from an interior space of the container housing.

14. The battery cooling system according to claim 12, further comprising a second spring that preloads the dryer cartridge against the container housing.

15. The battery cooling system according to claim 12, wherein at least one of:
the first shell and/or the second shell is configured as plastic injection-molded part, and
the first shell and the second shell are welded, clipped, screwed, or glued together.

16. The battery cooling system according to claim 12, wherein the first shell and/or the second shell is made of polyoxymethylene (POM) or polyketone.

17. The battery cooling system according to claim 12, wherein the first shell and/or the second shell comprise glass fibers.

18. The battery cooling system according to claim 12, wherein the second valve is arranged in an outer wall of the container housing which separates the first receptacle from the environment.

19. The battery cooling system according to claim 12, wherein the activated carbon is arranged as a bulk material in the cartridge housing.

20. The battery cooling system according to claim 12, wherein the cover is moveable like a piston in the body.
